(19) United States
(12) Patent Application Publication
(10) Pub. No.: US 2015/0310557 A1
(43) Pub. Date: Oct. 29, 2015

(54) System and Method for Intelligent Aerial Image Data Processing

(71) Applicant: STATE FARM MUTUAL AUTOMOBILE INSURANCE COMPANY, Bloomington, IL (US)

(72) Inventor: Amy Engelhorn, Normal, IL (US)

(73) Assignee: STATE FARM MUTUAL AUTOMOBILE INSURANCE COMPANY, Bloomington, IL (US)

(21) Appl. No.: 14/262,037

(22) Filed: Apr. 25, 2014

(51) Int. Cl. G06Q 40/08; G06K 9/00

(52) U.S. Cl. CPC G06Q 40/08; G06K 9/00637

(57) ABSTRACT

A computer implemented method for determining an insurance premium and/or eligibility is presented. The method receives a plurality of inputs associated with a user account, wherein at least one of the inputs corresponds to a geographic location and an aerial image, wherein the aerial image corresponds to the geographic location. The method further identifies a first data category from the image and a data value corresponding to the data category; determine eligibility, and then if applicable calculates an insurance quote, based on at least the data value.

### FIELD OF THE DISCLOSURE

The present disclosure generally relates to a system and method for retrieving aerial images and using the retrieved data to calculate a price quote, to gather research data, to gather data for underwriting eligibility purposes, or for inspection purposes for an insurance product.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many companies sell products which must be price quoted, purchased, and/or updated based on user specific information. Current methods for calculating price quotes require human intervention to determine information which the user cannot easily answer. An underwriter or sales associate must either look up data from alternative sources or go out to a site and take measurements. Similarly, underwriting and sales associates can be faced with tracking down data that is difficult to measure and collect in an efficient and effective manner. This process is labor intensive and causes delays in processing.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a computer implemented method for determining an insurance premium comprises receiving, via a computer network, a plurality of inputs associated with a user account, wherein at least one of the inputs corresponds to a geographic location and receiving, via the computer network, an aerial image, wherein the aerial image corresponds to the geographic location. The method also includes identifying, at one or more processors, a first data category from the image and determining, at the one or more processors, a data value corresponding to the data category. The method further includes calculating, at the one or more processors, an insurance quote, based on at least the data value.

### BRIEF DESCRIPTION OF THE DRAWINGS

FIG. 1 is a simplified and exemplary block diagram of a system for intelligent aerial image data processing;

FIG. 2 is an exemplary architecture of server of a system for intelligent aerial image data processing;

FIG. 3 is flow chart illustrating a method for intelligent aerial image data processing;

FIG. 4a is a flow chart illustrating a method for intelligent aerial image data analysis;

FIG. 4b is an exemplary aerial image;

FIG. 5 is a flow chart illustrating a method for determining a best aerial image data source;

FIG. 6 is a flow chart illustrating an exemplary method for identifying one or more objects in an aerial image; and

FIG. 7 is a flow chart illustrating an exemplary method for determining if two or more objects in an aerial image are within a threshold distance of each other.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

As the insurance quote process continues to become more automated and customers complete more of the data collection independently (i.e. without the assistance of a insurance agent or company employee), additional challenges arise as customers are being asked to locate and enter data that may be difficult to determine or collect. During an automated online quote process, customers can be faced with answering questions that are difficult to answer or obtain for a variety of reasons (i.e. lack of insurance knowledge or data availability).

For example, customers may be asked a series of questions regarding available fire protection for a dwelling (inside outside city limits, distance from servicing fire hall, distance to hydrant, superior shuttle tanker service eligibility). Based on how the customer responds, a business rule, such as a fire protection binding rule, may dictate whether the customer can obtain a quote, become ineligible, or will be referred to a marketing professional. If it is referred to a marketing professional, then manual intervention may be needed in certain markets where fire protection data is not commercially available. Often times, a customer may not know the answer to the question, but enter some information into the data field in order to continue the process or avoid having to call up the company and deal with a lengthy manual quote process. Customer guessing can impact data accuracy, while having a company agent manually determine and enter information slows down the quote processes and decreases efficiency.

Methods for intelligent aerial image data processing presented in this application capture & analyze data for use in the quote/purchase and servicing applications. The methods presented in the application may incorporate one or more algorithms which derive data from geocoded information or data points identified on the image. The methods presented provide an improved customer experience by avoiding situations where customers are asked to enter data that is difficult collect. Furthermore, data that is difficult to collect is obtained and interpreted without human intervention, saving time and avoiding delays during application and service.

The innovative data collection approach discussed below uses aerial imaging to collect data on behalf of the customer. The method collects and analyzes aerial image data points without human intervention and uses computer intelligence to identify, collect, and calculate data with or without available geocoding. The proposed methods may use a combination of existing geocoding and new algorithms for object detection, measurements, and analytics.

In this manner, the methods presented in this application provide improved data quality by reducing guessing and incorrect data submitted by customers. The methods provide for increased data availability and may also collect additional data for further analysis and research purposes. In some cases, the methods may allow collection of data previously unavailable in certain locations. For example, no vendor currently exists that can provide required Canadian fire protection data for every address.

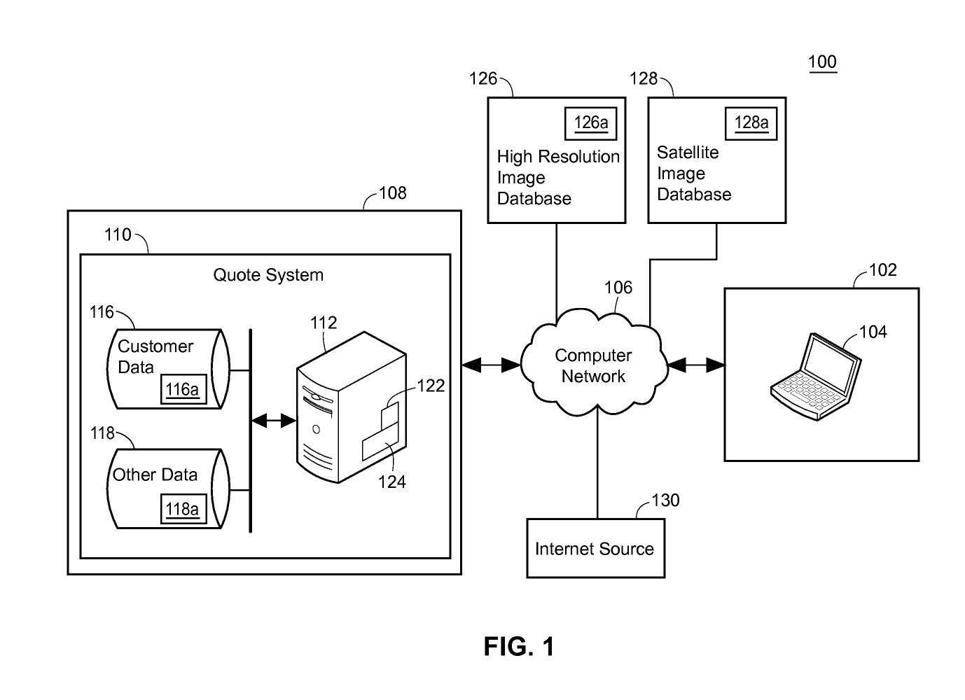

FIG. 1 illustrates various aspects of an exemplary architecture for implementing a intelligent aerial image data processing system 100. The high-level architecture includes both hardware and software applications, as well as various data communications channels for communicating data between the various hardware and software components. The intelligent aerial image data processing system 100 may include various software and hardware components or modules that may employ a method to analyze and process aerial images, such as satellite images, high resolutions images and other types of images. The various modules may be implemented as computer-readable storage memories containing computer-readable instructions (i.e., software) for execution by a processor of the intelligent aerial image data processing system 100.

The intelligent aerial image data processing system 100 may include front end components 102, including a computing device 104 that may execute instructions for performing a quote application process. The computing device 104 may include a personal computer, smart phone, tablet computer, or other suitable computing device. Those skilled in the art will recognize that the present system may be used in a dedicated application, a web browser, a combination thereof, etc.

In some embodiments, the computing device 104 connects to a computer network 106, such as the Internet or other type of suitable network (e.g., local area network (LAN), a metropolitan area network (MAN), a wide area network (WAN), a mobile, a wired or wireless network, a private network, a virtual private network, etc.). The computing device 104 may connect to back end components 108 via the computer network 106.

The back end components 108 may include a quote system 110 that processes quote applications submitted by the computing device 104 via the computer network 106. The quote system 110 includes a quote server 112 that may include computer-executable instructions to instantiate an aerial image retrieval tool 122 and an aerial image analysis tool 124. The quote system 110 may also include a customer data base 116 that stores data 116a associated with a customer. The customer database 116a may include a data storage device such as random-access memory (RAM), hard disk drive (HDD), flash memory, flash memory such as a solid state drive (SSD), etc. The quote system 110 may further include one or more additional databases 118 for storing other data 118a. The back end components may communicate with each other through a communication network 106 such as a local area network or other type of suitable network (e.g., the Internet, a metropolitan area network (MAN), a wide area network (WAN), a mobile, a wired or wireless network, a private network, a virtual private network, etc.).

The aerial image retrieval tool 122 of the quote server 120 may access and/or receive data from one or more sources via the computer network 106, such as a high resolution image database 126, a satellite image database 128, one or more internet sources 130, etc. The high resolution database 126 may include a data storage device such as random-access memory (RAM), hard disk drive (HDD), flash memory, flash memory such as a solid state drive (SSD), etc. Similarly, the satellite image database 128 may include a data storage device such as random-access memory (RAM), hard disk drive (HDD), flash memory, flash memory such as a solid state drive (SSD), etc. In some embodiments, the high resolution image database 126 and the satellite image database 128 may be third party databases, such as a private or a public database. The third party database may be offered, for example, by a third party vendor. In some embodiments, the high resolution image database 126 and the satellite image database 128 may be included in the back end components 108 and/or the quote system 110 and may also be accessed by the aerial image retrieval tool 122 via the communication network 106.

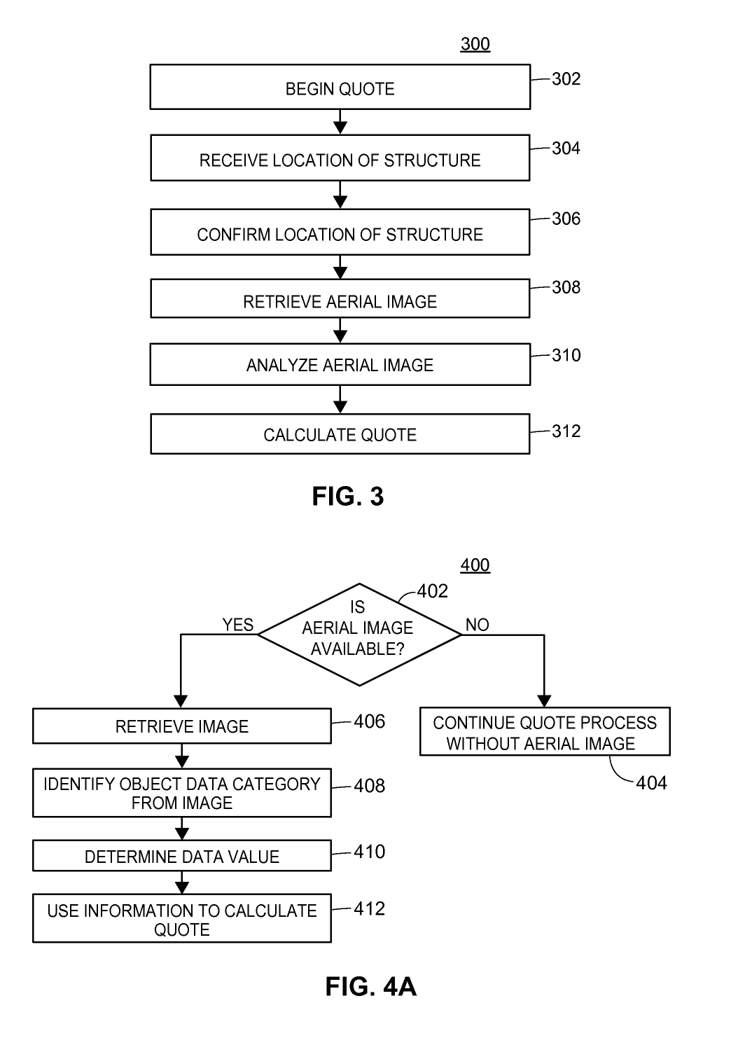

The aerial image analysis tool 124 may analyze one or more images retrieved from the high resolution image database 126, the satellite image database 128, internet source 130, etc. As will be discussed below in reference to FIGS. 3-7, the aerial image analysis tool 124 may perform a variety of analysis, such as identifying one or more data objects, translating one or more data objects, etc.

The quote server 112 may send and receive information such as computer-executable instructions and data associated with applications executing on the computing device 104. The applications executing within the system 100 may include cloud-based applications, web-based interfaces to back end components 108, software applications executing on the computing device 104, or applications including instructions that are executed and/or stored within any component of the system 100. The back end components 108 may receive, via the computer network 108, a file, such as a high resolution image 126a from the high resolution database 126, satellite image 128a from a satellite image database, etc. The backend components 108 may communicate with the computing device 104 through the quote server 110 via the computer network 106. The applications, web browser application, and other tools may be stored in various locations, including separate repositories and physical locations.

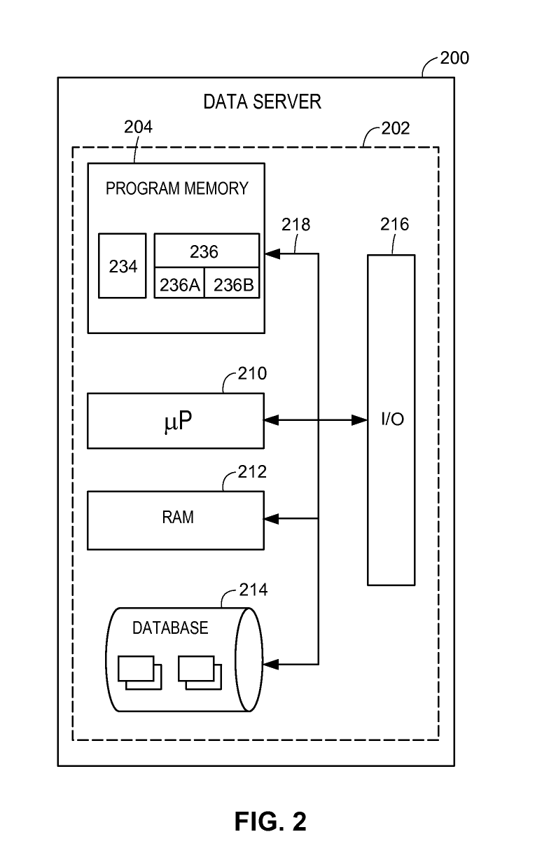

Referring now to FIG. 2, a data server 200 includes a controller 202. Exemplary data servers include the quote server 112 illustrated in FIG. 1. The controller 202 includes a program memory 204, a microcontroller or a microprocessor (μP) 210, a random-access memory (RAM) 212, and an input/output (I/O) circuit 216, all of which are interconnected via an address/data bus 218. The program memory 204 may store computer-executable instructions, which may be executed by the microprocessor 210. In some embodiments, the controller 202 may also include, or otherwise be communicatively connected to, a database 214 or other data storage mechanism (e.g., one or more hard disk drives, optical storage drives, solid state storage devices, etc.). It should be appreciated that although FIG. 2 depicts only one microprocessor 210, the controller 202 may include multiple microprocessors 210. Similarly, the memory 204 of the controller 202 may include multiple RAMs 234 and multiple program memories 236, 236A and 236B storing one or more corresponding application modules, according to the controller's particular configuration. The data server 200 may also include specific routines to be performed by the data server 200.

Although FIG. 2 depicts the I/O circuit 216 as a single block, the I/O circuit 216 may include a number of different types of I/O circuits (not depicted). The RAM(s) 212, 234 and the program memories 236, 236A and 236B may be implemented in a known form of computer storage media, including but not limited to, semiconductor memories, magnetically readable memories, and/or optically readable memories, for example, but does not include transitory media such as carrier waves.

FIG. 3 is a high level flow chart of a method, routine or process 300 for intelligent aerial image data processing. A user, such a customer of the company, a holder of an insurance policy of the company, a beneficiary of a policy, a claimant, an insurance agent with the company or some other employee or independent contractor affiliated with the company, may use a client device, such as the computing device 108 illustrated in FIG. 1 to access a company website. The company website may be hosted on one or more servers, such as the server 122, described in reference to FIG. 1. Furthermore, the servers may include one or more instructions to execute an interface for purchasing and quoting insurance products.

The user, such as a customer, agent, company representative, etc. may enter an input, via a mouse click, touch press, etc., representing the product to be quoted. For example, the user may select a insurance product for a structure, such as a house. In response to receiving the user input representing the selection of a product to be quoted, the server may execute an instruction to begin the quote process (block 302). As part of the quote process, the processor may also execute an instruction to transmit one or more questions relating to the quote to be displayed on the client device. For example, one such question may relate to a geographic location of the structure, such as the dwelling. For instance, a home insurance product may have one or more questions relating to the address of the house, a commercial insurance may include one or more questions relating to the address of the business, a vehicle insurance product may include one or more questions relating to the geographic region where the car is garaged. Accordingly, the user may enter an input indicating an answer to the one more questions. More specifically, the input may also correspond to a location or characteristics of the structure.

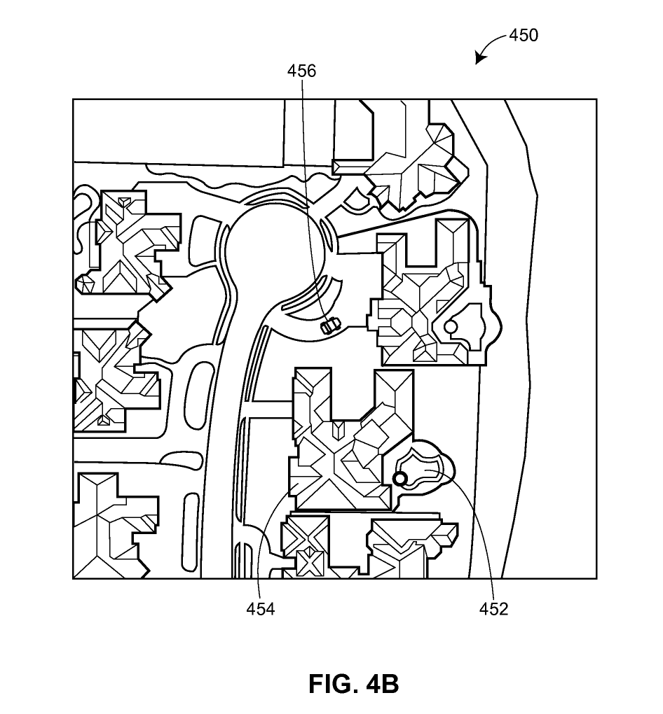

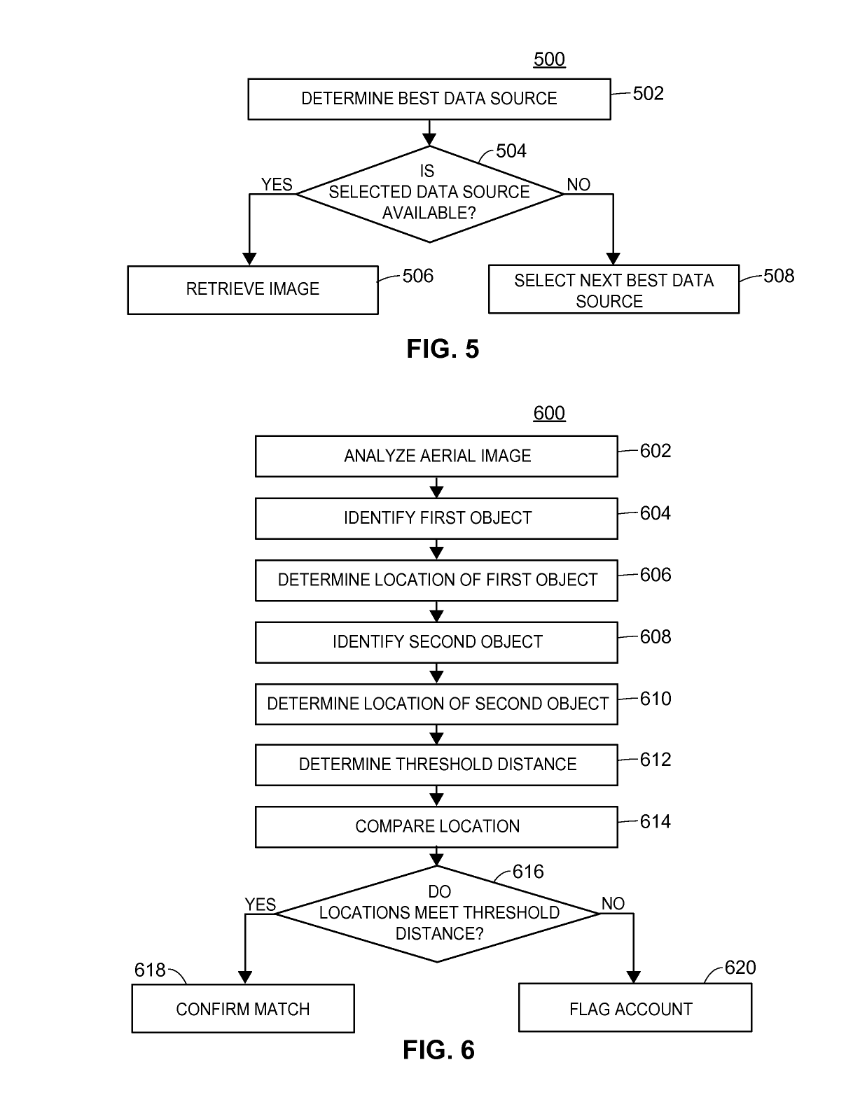

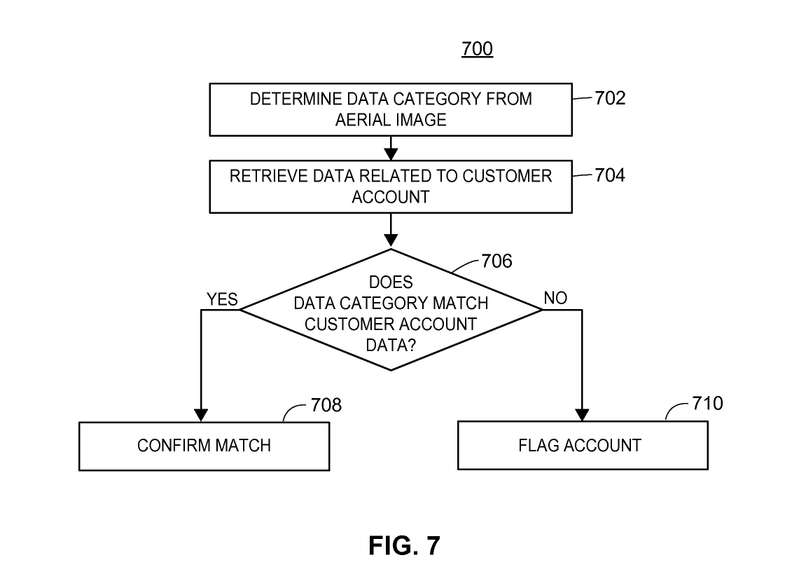

The server may receive the input corresponding to the location of the structure (block 304) and execute an instruction to confirm the location of the structure (block 306). For example, the processor may execute an instruction to check the location of the structure in one or more databases, such as company databases, 3^{rd} party databases, public databases, etc, to correspond that the structure exists and that the user has formatted the address properly. The processor may then execute an instruction to retrieve an aerial image of the structure (block 308) and to analyze the aerial image of the structure (block 310). For example, the processor may execute one or more instructions corresponding to the methods 400 discussed in reference to FIG. 4a, method 500 discussed in reference to FIG. 5, method 600 discussed in reference to FIG. 6, method 700 described in reference to FIG. 7, etc. In some embodiments, the processor may execute an instruction to retrieve and analyze aerial images of an area within a threshold distance of the structure. For example, the processor may execute an instruction to retrieve and analyze an aerial image of a 3 mile radius surrounding the structure, all structures within a 10 mile radius, etc. Of course these are only examples and many different threshold values can be used. The processor may also execute an instruction to collect data from the analysis of the aerial image.

The processor may further execute an instruction to adjust a user account setting based on the analysis (block 312). For example, the processor may execute an instruction to determine if the customer is eligible for one or more company products. In some embodiments, the processor may alternatively or additionally execute an instruction to calculate a price quote for the selected product, using at least some of the data collected from the analysis. In some embodiments, The processor may also execute an instruction to end the quote process. As is known in the art, the quote process may include one or more other steps, such as presenting the quote to the user, collecting additional information, accessing one or more additional databases or sources of information, etc.

FIG. 4a is a flow chart of a method, routine or process 400 for intelligent aerial image data analysis. As discussed above in reference to FIG. 3, a quote process for an insurance product may include retrieving and analyzing an aerial image to determine data used to adjust a user account setting, such as calculating a price quote for the insurance product. The method 400 may be used during an application process, such as the method 300 described in reference to FIG. 3, a renewal review process, etc., though those skilled in the art will recognize that the method 400 can be used in a variety of different price quote application processes for one or more insurance products.

The processor of a server, such as the server 112, illustrated in FIG. 1, may execute an instruction to determine if an aerial image is available (block 402). The server 122 may access a company database, such as the database 116 or 118 illustrated in FIG. 1, an aerial image database, such as the high resolution image database, 126, satellite image database 128 illustrated in FIG. 1, an internet source, such as the internet source 130 described in FIG. 1, etc. In some embodiments, the company may use a database or other source maintained by the company, while in other embodiments the server may access a database that is maintained by a third party. If an aerial image for the structure is not available (NO branch of block 402), the processor may execute an instruction to continue the method without analyzing an aerial image or request an aerial image (block 404) and end the method 400. In some embodiments, the processor may execute an instruction to transmit a message to the user requesting permission to order an aerial image on demand. For example, if the server receives an input from the user granting permission to order the aerial image, the processor may execute an instruction to message one or more on demand image services, such as a company image service or a third party service, placing a request for an image of the specified structure and/or location. Depending on how long the image service takes to provide the image, the processor may receive the image and continue the method from the YES branch of block 402, the processor may end or pause the method until a later time when the image is delivered, etc.

If the processor executing the instruction determines that an aerial image for the structure is available, (YES branch of block 402) the processor may execute an instruction to retrieve the aerial image for the structure (block 406). The processor may further execute an instruction to identify one or more object data categories from the retrieved aerial image (block 408). The processor may further execute an instruction to determine one or more data values corresponding to the object data categories (410).

As a general example, the aerial image retrieved may be of a structure such as a home. Accordingly, the processor may execute an instruction to analyze the image and translate the object data categories. Exemplary data categories may include a roof, a pool, detached structures, property slope or other building characteristics, etc. Once the data category has been identified, the processor may execute an instruction to determine one or more object data values corresponding to the data category. In the roof example, the object data value may correspond to the roofing material and include, for example, shingles, slate, ceramic tile, copper, concrete, etc. Another value may correspond to a quality or condition of the roof and/or roofing material and may be on a scale of 1-10, a percentage, or some other value. If the identified data category is a pool, the data values identified may be the type of pool, such as if the pool is in-ground, above ground, the approximate size of the pool, fencing etc. The object data values may be objective data, such as whether an object data (such as a pool) is present, or a subjective value, describing the pool (in-ground, above ground, etc.). The object data categories and values may also be structured data retrieved from the image file, such as geocoded data, etc. Of course these are just examples and the data categories can be any of a wide variety of objects, etc. For example, if the structure is a commercial building, the object data categories may include a drive way, a fire hydrant, etc.

The processor may execute an instruction to process one or more insurance options, such as to determine eligibility for an insurance product, calculate a price quote (block 412), using, for example, at least one of the object data values, etc. In some embodiments, the processor may also incorporate one or more business rules into the instruction. For example, a business rule may specify that if the structure includes a roof made of shingles, that the risk of insurance may be greater. In some embodiments, the processor may also use the information retrieved from the object data categories and/or object data values to determine one or more answers for questions in the quote process and auto-populate a form corresponding to the quote process, such as an online form for an online quote process executing on a client device. The server may also execute an instruction to transmit the information to the client device for presentation, confirmation, etc.

Turning briefly to FIG. 4b, a sample aerial image 450 is provided. In the context of this disclosure an aerial image can be any image of a structure and/or an area surrounding the structure with identifiable data of the structure and/or surrounding area. For example, the image can be a high resolution image, a satellite image, an image sent by a customer or any of a variety of images. The processor executing the instructions may identify one or more object data categories, such as a house 454, a pool 45 and a garage. Furthermore, the processor executing the instructions may determine a data value for one of the identified object data categories. As one example, the processor executing the instruction may determine that data value for the pool 452, is that the pool is a in-ground pool. Of course this is just one example, and the methods provided can be used with any variety of aerial images, data values and data categories, etc.

FIG. 5 is a flow chart of a method, routine or process 500 for determining a best aerial image data source. In some embodiments, multiple data sources for aerial images may exist. For example, the server 122 may have access to one or more databases, including third party databases from multiple sources and/or one or more additional sources, such as the databases 116, 118, 126, 128, internet source 130, discussed in reference to FIG. 1. The processor may execute an instruction to determine the best data source (block 502). This may be done in a variety of ways. For example, the processor may execute an instruction to retrieve at least one image from each of the available data sources and to determine one of more characteristics of the image files retrieved, such as resolution, file format, etc. In some embodiments, one or more of the aerial image files and/or sources may be graded based on reliability. In some embodiments, the server may store previous determinations and execute an instruction to determine which is the best source available based on previous decisions.

Nonetheless, once the processor executing the instructions determines the best data source, the processor may execute an instruction to determine if the best data source is available for the desired structure (block 504). If the best data source is available for the desired structure, (YES branch of block 504), the processor may execute an instruction to retrieve one or more aerial images from the data source (block 506).

If the processor executing the instruction determines that the best data source is not available for the desired structure (NO branch of block 504), the processor may execute an instruction to select the next best data source (block 508) and determine whether the select data source is available for the structure (block 504). The processor may continue to execute instructions incorporating the method until a suitable source is found. In some embodiments, the processor may end the method 500 after a certain number of sources, certain amount of time, etc.

FIG. 6 is a flow chart of a method, routine or process 600 for determining if two or more objects in an aerial image are within a threshold distance of each other. In some embodiments, an aerial image may have one or more relevant objects present. For example, in determining eligibility for or an insurance quote for a home, it may be relevant if the structure includes a pool in the backyard, a garage, a fence, a nearby fire hydrant, a nearby fire station, a nearby police station etc. Accordingly, the processor may execute an instruction to analyze the aerial image (block 602), identify a first object (block 604) and determine the location of the first object (block 606). The instruction executed by the processor may incorporate one or more image identifying techniques as are known on the art. The processor may further execute an instruction to identify a second object (block 608) and determine the location of the second object (block 610). In some embodiments, the first object and second object may correspond to one or more of the object data categories determined by the method 400, discussed above in reference to FIG. 4a. Furthermore, although this discussion only mentions a first and a second object, those skilled in the art will recognize that the method 600 can involve any number of identified object data.

The processor may execute an instruction to determine a threshold distance (block 612), compare the locations of the first and second object (block 614) and determine if the locations meet the threshold distance (block 616). If the processor determines that the location meets the distance threshold, the processor executing the instruction may confirm the match (block 618). If the processor determines that the location does not meet the threshold distance, the processor executing the instruction may flag a value, such as a data value, associated with the customer account (block 620). For example, if the processor executing the instruction determines that the location does not meet the threshold distance, the processor may execute an instruction to flag a data value corresponding to an eligibility requirement. In some embodiments, the processor may also use the confirmation to determine one or more answers for questions in the quote process and auto-populate a form corresponding to the quote process, such as an online form for an online quote process executing on a client device. The server may also execute an instruction to transmit the information to the client device for presentation, confirmation, etc.

For example, a processor of the server may execute an instruction incorporating the method 600 to determine if a fire station is within a threshold distance of a home. A user may wish to receive a quote on a home insurance product, but a business rule may determine, for example, that a certain additional premium is to be charged if the customer's home is not within a threshold distance, for example five miles, of a fire station. In another example, the business rule may determine that a customer may not be eligible for an insurance product if the customer's home is not within a threshold distance, for example five miles, of a fire station. Accordingly, the processor may execute an instruction to analyze the aerial image and identify a first object, such as the home structure itself. The processor may further execute an instruction to identify a second object, such as the fire station. The processor may then execute an instruction to compare the distances of the home structure and the fire station and determine whether or not the fire station is within the threshold distance of the home structure. Of course this is only an example for demonstration purposes, and the method 600 can be used with any variety of objects and/or threshold distances.

FIG. 7 is a flow chart of a method, routine or process 700 for using aerial image data processing to confirm information during an insurance quote. In some embodiments, aerial image data may be used to confirm information entered by a user during the insurance process. For example, during the quote process, a user may enter information about the surroundings of the customer's home, such as that they have a fire hydrant in front of their house or that they have a pool. Traditionally, the only way that an insurance company could determine if this information was accurate was to have an agent, a company employee, or a third party vendor may physically go to the structure (such as a home, commercial building, factory, etc.) and perform an inspection.

As another example, a user may have inadvertently stated that their roof was made of concrete, where it is actually made of a separate material. The processor executing the instructions may identify the error to transmit a message to convey this information to the user, process one or more insurance options, auto populate the new information in an insurance quote, determine eligibility, adjust the price of the insurance quote, transmit the information to an agent, etc.

Referring back to the method 700, the processor may execute an instruction to determine a data category from an aerial image (block 702). The instruction executed may incorporate one or more steps of the method 400, for example, as described above in reference to FIG. 4a. The processor may also execute an instruction to retrieve one or more data values related to the customer account (block 704). The data values may be stored in one or more databases, such as the database 116 and 118 discussed in reference to FIG. 1. The processor may execute an instruction to compare the saved data value to the data category value retrieved from the aerial image and determine if the aerial image data matches the saved data (block 706). If the processor executing the instructions determines that the data does match (YES branch of block 706), the processor may execute an instruction to confirm the match (block 708). If the processor executing the instruction determines that the data does not match (NO branch of block 706), the processor may execute an instruction to flag the customer account (block 710). In some embodiments, the processor may also execute an instruction to transmit the information to a company employee.

The following additional considerations apply to the foregoing discussion. Throughout this specification, plural instances may implement functions, components, operations, or structures described as a single instance. Although individual functions and instructions of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The methods described in this application may include one or more functions or routines in the form of non-transitory computer-executable instructions that are stored in a tangible computer-readable storage medium and executed using a processor of a computing device (e.g., the computing device 104, the server 112, or any combination of computing devices within the system 100). The routines may be included as part of any of the modules described in relation to FIG. 1 or 2 or as part of a module that is external to the system illustrated by FIGS. 1 and 2. For example, the methods may be part of a browser application or an application running on the computing device 104 as a plug-in or other module of the browser application. Further, the methods may be employed as “software-as-a-service” to provide a computing device 104 with access to the quote system 110.

Additionally, certain embodiments are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain functions. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or functions described herein may be at least partially processor-implemented. For example, at least some of the functions of a method may be performed by one or processors or processor-implemented hardware modules. The performance of certain of the functions may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors), these operations being accessible via a network (e.g., the Internet) and via one or more appropriate interfaces (e.g., application program interfaces (APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “function” or an “algorithm” or a “routine” is a self-consistent sequence of operations or similar processing leading to a desired result. In this context, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a computer system 100 for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for intelligent aerial image data processing. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

To the extent that any meaning or definition of a term in this document conflicts with any meaning or definition of the same term in a document incorporated by reference, the meaning or definition assigned to that term in this document shall govern. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A computer implemented method for determining an insurance premium, the method comprising:
receiving, via a computer network, a plurality of inputs associated with a user account, wherein at least one of the inputs corresponds to a geographic location;
receiving, via the computer network, an aerial image, wherein the aerial image depicts a structure located at the geographic location and a threshold distance surrounding the structure;
identifying, at one or more processors, a first data category of an object depicted in the image, wherein the object is depicted within the threshold distance surrounding the structure;
determining, at the one or more processors, a data value describing the object in further detail, wherein the data value is indicative of at least one of (i) a particular type, among a plurality of types associated with the first data category, of the object, (ii) a particular material, among a plurality of materials associated with the first data category, of the object, (iii) a quality or condition of the object, or (iv) a size of the object;
determining, at the one or more processors, that the data value matches a business rule; and
processing an insurance option, at the one or more processors, based on the data value matching the business rule.

2. The computer implemented method of claim 1, further comprising:
automatically populating, with the one or more processors, a field of a price quote application with the data value.

3-4. (canceled)

5. The method of claim 1, further comprising:
accessing, via the computer network, one or more aerial image databases; and
determining, at the one or more processors, that at least one aerial image database contains an aerial image corresponding to the geographic location.

6. The computer implemented method of claim 5, wherein at least one of the aerial image databases is a third party database.

7. The computer implemented method of claim 6, wherein determining, at the one or more processors, that at least one aerial image database contains an aerial image corresponding to the geographic location, further includes:
requesting, via the computer network, one or more on demand aerial images corresponding to the geographic location.

8. A computer device for determining an insurance premium, the computer device comprising;
one or more processors; and
one or more memories coupled to the one or more processors;
wherein the one or more memories include computer executable instructions stored therein that, when executed by the one or more processors, cause the one or more processors to:
receive, via a computer network, a plurality of inputs associated with a user account, wherein at least one of the inputs corresponds to a geographic location;
receive, via the computer network, an aerial image, wherein the aerial image depicts a structure located at the geographic location and a threshold distance surrounding the structure;
identify a first data category of an object depicted in the image, wherein the object is depicted within the threshold distance surrounding the structure;
determine a data value describing the object in further detail, wherein the data value is indicative of at least one of (i) a particular type, among a plurality of types associated with the first data category, of the object, (ii) a particular material, among a plurality of materials associated with the first data category, of the object, (iii) a quality or condition of the object, or (iv) a size of the object;
determine that the data value matches a business rule; and
process an insurance option based on the data value matching the business rule.

9. The computer device of claim 8, wherein the computer executable instructions further cause the one or more processors to:
populate a field of a price quote application with the data value.

10-11. (canceled)

12. The computer device of claim 8, wherein the computer executable instructions further cause the one or more processors to:
access, via the computer network, one or more aerial image databases; and
determine that at least one aerial image database contains an aerial image corresponding to the geographic location.

13. The computer device of claim 12, wherein at least one of the aerial image databases is a third party database.

14. A non-transitory computer readable storage medium comprising non-transitory computer readable instructions stored thereon determining an insurance premium, the instructions when executed on one or more processors cause the one or more processors to:
receive, via a computer network, a plurality of inputs associated with a user account, wherein at least one of the inputs corresponds to a geographic location;
receive, via the computer network, an aerial image, wherein the aerial image depicts a structure located at the geographic location and a threshold distance surrounding the structure;
identify a first data category of an object depicted in the image, wherein the object is depicted within the threshold distance surrounding the structure;
determine a data value describing the object in further detail, wherein the data value is indicative of at least one of (i) a particular type, among a plurality of types associated with the first data category, of the object, (ii) a particular material, among a plurality of materials associated with the first data category, of the object, (iii) a quality or condition of the object, or (iv) a size of the object;
determine that the data value matches a business rule; and
process an insurance option based on the data value matching the business rule.

15. The non-transitory computer readable storage medium of claim 14, wherein the instructions when executed on the one or more processors further cause the one or more processors to:
populate a field of a price quote application with the data value.

16. The non-transitory computer readable storage medium of claim 14, wherein the instructions when executed on the one or more processors further cause the one or more processors to:
decline an application based on the data value.

17-19. (canceled)

20. The non-transitory computer readable storage medium of claim 14, wherein the instructions when executed on the one or more processors further cause the one or more processors to:
access, via the computer network, one or more aerial image databases; and
determine that at least one aerial image database contains an aerial image corresponding to the geographic location.

21. The computer implemented method of claim 1, wherein the data value is indicative of a particular material, among a plurality of materials associated with the first data category, of the object.

22. The computer implemented method of claim 1, wherein the data value is indicative of one or both of (i) a quality or condition of the object, or (ii) a size of the object.

23. The computer device of claim 8, wherein the data value is indicative of a particular material, among a plurality of materials associated with the first data category, of the object.

24. The computer device of claim 8, wherein the data value is indicative of one or both of (i) a quality or condition of the object, or (ii) a size of the object.

25. The non-transitory computer readable storage medium of claim 14, wherein the data value is indicative of a particular material, among a plurality of materials associated with the first data category, of the object.

26. The non-transitory computer readable storage medium of claim 14, wherein the data value is indicative of one or both of (i) a quality or condition of the object, or (ii) a size of the object.
